(19) United States
(12) Patent Application Publication
(10) Pub. No.: US 2026/0164402 A1
(43) Pub. Date: Jun. 11, 2026

(54) SUBSCRIBER IDENTITY MODULE LOCATION HISTORY VERIFICATION

(71) Applicant: T-MOBILE INNOVATIONS LLC, Overland Park, KS (US)

(72) Inventors: Kulandaivel MARAPPA GOUNDER, Bothell, WA (US); Kyeong Hun AN, Sammamish, WA (US); Nilesh RANJAN, Sammamish, WA (US)

(21) Appl. No.: 18/973,989

(22) Filed: Dec. 9, 2024

(51) Int. Cl. H04W 64/00; H04W 8/18

(52) U.S. Cl. CPC H04W 64/006; H04W 8/183

(57) ABSTRACT

Embodiments of the present disclosure are directed to systems and methods for determining and storing historical location data of a user device using a subscriber identity module (SIM) in a mobile communication device. This mechanism allows the SIM to detect when the user device has moved to a new location, capture location data, and store a historical location record. The system's operations include determining that the user device has moved based on attachment to a new cell site, requesting location data including network measurement reports (NMRs) and cell site location information (CGIs) from the device, and using a triangulation algorithm to compute the historical and current locations of the user device. The determined locations are securely stored within the SIM and can be transmitted to an external server upon request from the network.

### SUMMARY

The present disclosure is directed, in part, to methods and systems for enhancing location-based services in mobile communication devices through the use of a subscriber identity module (SIM) applet, substantially as shown and/or described in connection with the figures. This disclosure provides innovative mechanisms for utilizing a SIM applet to request and process location data, thereby enabling advanced location-based functionalities.

According to various aspects of the technology, the disclosed methods introduce solutions to the problem of obtaining accurate and secure historical and real-time location information in mobile communication networks. By implementing a SIM applet capable of interacting with the user device and external servers, the disclosed methods and systems ensure that both current and historical location data can be accurately collected, processed, stored, and utilized for various applications. These outcomes are achieved through a method where the SIM applet requests network measurement reports (NMR) and cell global identity (CGI) data to triangulate the device’s location following a determination that the device has moved. These locations are used to generate a location history for the user device. Additionally, the current location is determined following a request from an external server. The stored location history, as well as the current location, are securely transmitted to external servers, providing real-time location services as well as access to historical location records. This method and system leverages the capabilities of the SIM applet to not only provide secure and accurate location-based services but also to maintain and share historical movement data.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an exemplary network environment in which implementations of the present disclosure may be employed;

FIGS. 4A and FIG. 4B illustrate an exemplary network environment in which implementations of the present disclosure may be employed; and

FIG. 5 illustrates a flow diagram of an exemplary method for determining the location of a user device using a SIM.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Modern mobile communication networks rely heavily on precise and secure location-based services to provide users with accurate positioning, navigation, and various location-dependent applications. A critical component in enabling these services is the SIM card, which can be enhanced to collect and transmit location data securely and efficiently. Users of mobile networks often require both real-time and historical location data for purposes such as navigation, tracking, emergency services, and business analytics.

As used herein, “network measurement reports (NMR)” may refer to a report generated by a user device that provides metrics on signal quality and performance for the serving cell and neighboring cells. The NMR may include measurements such as received signal strength (RSSI) and signal-to-noise ratios. These reports may be generated periodically or in response to network requests.

As used herein, “cell global identity (CGI)” may refer to a unique identifier assigned to a cell in a network. CGI may include a structured code that helps networks and devices identify specific cells, which may support functions such as call routing and handover management. CGI may comprise several components such as the Mobile Country Code (MCC), the Mobile Network Code (MNC), the Location Area Code (LAC), and/or the Cell Identity (CI), which may be used to identify cell-level locations within communications networks.

As used herein, “SIM applet” may refer to an application installed on a SIM card within a user device. A SIM applet may run directly on the SIM card’s secure, embedded environment, which helps enable them to perform tasks independently from the device’s operating system. In some aspects, SIM applets may manage a range of activities such as authentication, providing secure storage for cryptographic keys, facilitating secure transactions, and interacting with the network through SIM Application Toolkit (SAT) commands. SIM applets may also help support functions like secure messaging, network-based authentication, and/or location-based services.

Conventionally, obtaining accurate and secure historical location data has been challenging due to reliance on external applications or additional hardware. These methods often lack the integration and security features provided by SIM-based solutions. Existing solutions do not leverage the potential of the SIM card to serve as a central hub for collecting and transmitting historical location data. As a result, there is a gap in the ability to provide seamless, secure, and integrated historical location-based services directly from the SIM, leading to inefficiencies and potential security risks.

In contrast to conventional solutions, the present disclosure provides a method that leverages the capabilities of a SIM applet to enhance historical location-based services. The disclosed method includes a SIM applet that collects and stores historical location data at periodic intervals and based on movement of the user device. This data is securely transmitted to external servers, allowing businesses to query and retrieve historical location information for analysis and tracking purposes. By utilizing the SIM applet for this purpose, the invention ensures that historical location data is collected and transmitted securely, enhancing overall network integrity and providing valuable insights for various application.

Accordingly, a first aspect of the present disclosure provides a system for determining and storing historical location data of a user device. This system comprises one or more computer processing components configured to perform specific operations designed to accurately locate the user device within a mobile communication network and maintain a historical record of its locations. The operations begin with determining, by an application installed on a SIM within the user device, that the user device has moved locations. Upon detecting this movement, the SIM application requests, from the user device, one or more NMRs and one or more CGIs for each cell site that the user device is attached to. These NMRs include signal measurements such as received signal strength indicator (RSSI), reference signal received power (RSRP), and signal-to-noise ratio (SNR), while CGIs provide the identification of the specific locations of the cell sites. Following this, the system determines the location of the user device using a triangulation algorithm that processes the one or more NMRs and the one or more CGIs. The triangulation algorithm analyzes the signal measurements and computes the distances between the user device and the cell sites based on the NMRs and CGIs. The determined location data is then stored to create a historical location record. Finally, following the receipt of a request by an external server, the system communicates the historical location record and a current location of the user device to an external server, ensuring that the location information is securely transmitted to the network or service provider requesting it.

In a second aspect of the present disclosure, a method for determining and storing historical location data of a user device is provided. This method comprises a sequence of steps that the SIM performs to accurately locate the user device within a mobile communication network and maintain a historical record of its locations. The method begins with determining, by an application installed on a subscriber identity module (SIM) within the user device, that the user device has moved locations. The SIM application detects this movement and prepares to collect the required data from the user device. The next step involves requesting, from the user device by the application, one or more NMRs and one or more CGIs for each cell site that the user device is attached to. The user device collects signal measurements (RSSI, RSRP, SNR) from all connected cell sites and retrieves the CGIs for each cell site, identifying their specific locations. Upon receiving the NMRs and CGIs, the method proceeds to determine the location of the user device using a triangulation algorithm. The triangulation algorithm processes the received NMRs and CGIs to calculate the location of the user device by analyzing the signal measurements, computing distances, and determining the intersection point of the computed distances. The determined location data is then stored to create a historical location record. Finally, the method involves communicating the historical location record and the current location of the user device to an external server, ensuring that the location information is securely delivered to the network or service provider requesting it.

Another aspect of the present disclosure is directed to a non-transitory computer-readable medium having instructions stored thereon that, when executed by one or more computer processing components, cause the one or more computer processing components to perform a method for determining and storing historical location data of a user device. The method comprises several key steps designed to accurately locate the user device within a mobile communication network and maintain a historical record of its locations. The method begins with determining, by an application installed on a SIM within the user device, that the user device has moved locations. Upon detecting this movement, the SIM application prepares to process the request by engaging with the user device's internal components and network interfaces. The next step involves requesting, from the user device by the application, one or more NMRs and one or more CGIs for each cell site that the user device is attached to. The user device collects signal measurements (RSSI, RSRP, SNR) from all connected cell sites and retrieves the CGIs for each cell site, identifying their specific locations. The method then proceeds to determine the location of the user device using a triangulation algorithm that processes the received NMRs and CGIs. The triangulation algorithm analyzes the signal measurements, computes distances, and determines the intersection point of the computed distances to pinpoint the location of the user device. The determined location data is then stored to create a historical location record. Finally, the method involves communicating the historical location record and the current location of the user device to an external server, ensuring that the location information is securely transmitted to the network or service provider requesting it.

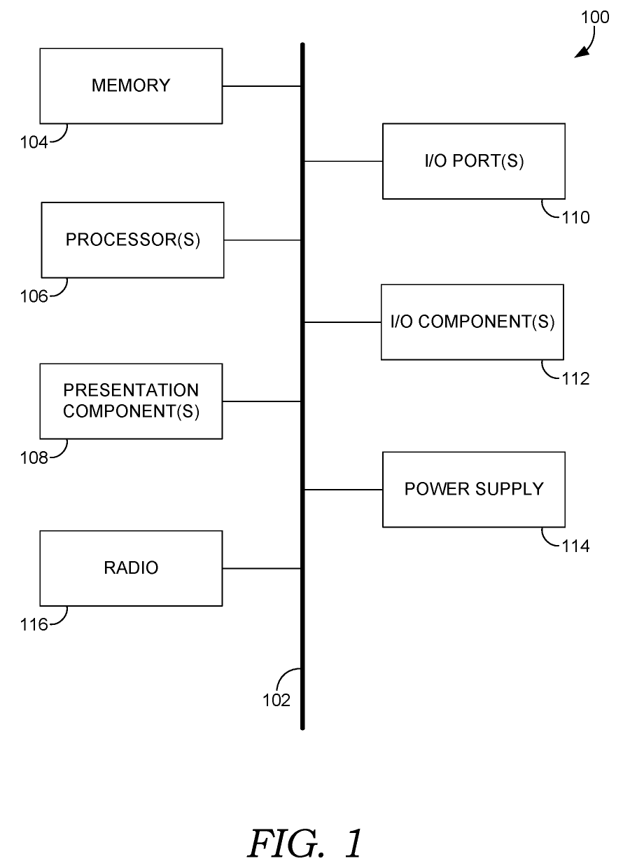

Referring to the drawings in general, and initially to FIG. 1, an exemplary computing environment 100 suitable for practicing embodiments of the present technology is provided. Computing environment 100 is just one example, and is not intended to suggest any limitation as to the scope of use or functionality of the embodiments discussed herein. Furthermore, the computing environment 100 should not be interpreted as having any dependency or requirement relating to any one or a combination of components illustrated. It should be noted that although some components in FIG. 1 are shown in the singular, they might be plural. For example, the computing environment 100 might include multiple processors and/or multiple radios. As shown in FIG. 1, computing environment 100 includes a bus 102 that directly or indirectly couples various components together, including memory 104, processor(s) 106, presentation component(s) 108 (if applicable), radio(s) 116, input/output (I/O) port(s) 110, input/output (I/O) component(s) 112, and power supply 114. More or fewer components are possible and contemplated, including in consolidated or distributed form.

Memory 104 may take the form of memory components described herein. Thus, further elaboration will not be provided here, but it should be noted that memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. Processor 106 may actually be multiple processors that receive instructions and process them accordingly. Presentation component 108 may include a display, a speaker, and/or other components that may present information (e.g., a display, a screen, a lamp (LED), a graphical user interface (GUI), and/or even lighted keyboards) through visual, auditory, and/or other tactile cues.

Radio 116 may facilitate communication with a network, and may additionally or alternatively facilitate other types of wireless communications, such as Wi-Fi, WiMAX, LTE, and/or other VoIP communications. In various embodiments, the radio 116 may be configured to support multiple technologies, and/or multiple radios may be configured and utilized to support multiple technologies. The input/output (I/O) ports 110 may take a variety of forms. Exemplary I/O ports may include a USB jack, a stereo jack, an infrared port, a firewire port, other proprietary communications ports, and the like. Input/output (I/O) components 112 may comprise keyboards, microphones, speakers, touchscreens, and/or any other item usable to directly or indirectly input data into the computing environment 100. Power supply 114 may include batteries, fuel cells, and/or any other component that may act as a power source to supply power to the computing environment 100 or to other network components, including through one or more electrical connections or couplings. Power supply 114 may be configured to selectively supply power to different components independently and/or concurrently.

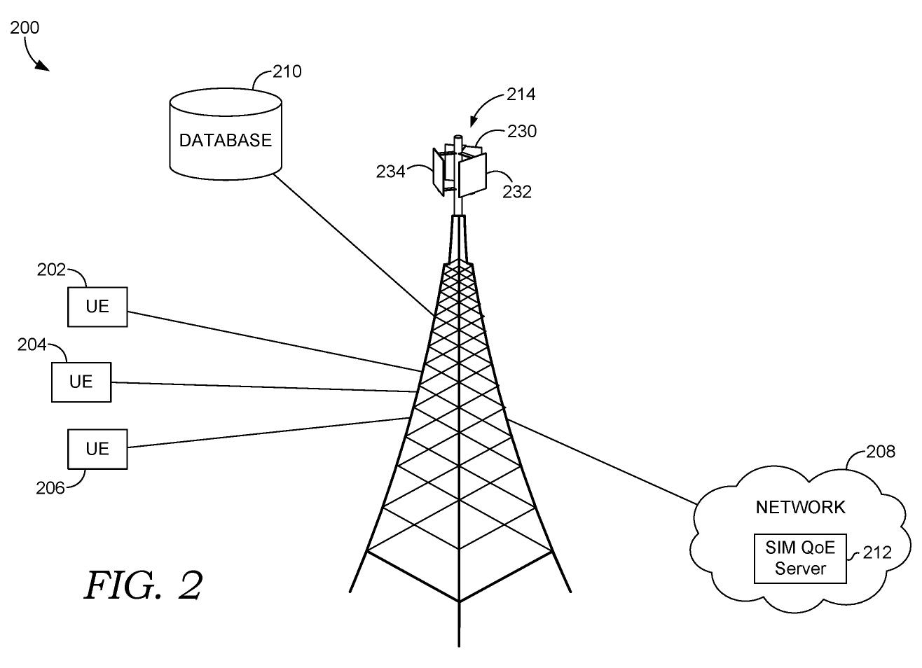

FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 includes one or more user devices (e.g., user devices 202, 204, and 206), cell site 214, network 208, database 210, and SIM Quality of Experience (QoE) server 212. In network environment 200, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a global positioning system (GPS) device, a video player, a handheld communications device, a workstation, a router, an access point, and any combination of these delineated devices, or any other device that communicates via wireless communications with a cell site 214 in order to interact with a public or private network.

In some aspects, the user devices 202, 204, and 206 correspond to computing device 100 in FIG. 1. Thus, a user device may include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, 6G, CDMA, or any other type of network.

In In other aspects, the user devices 202, 204, and 206 encompass a diverse range of high-throughput and high data consumption devices, catering to various user needs and environments. The first device, 202, corresponds to a Home Internet Network Terminal (HINT). Device 204 represents a Fixed Wireless Access (FWA) device, which provides internet access in areas where wired connectivity is limited or unavailable.

Additionally, the user devices 202, 204, and 206 can be any device characterized by high data throughput needs, such as advanced gaming consoles that require rapid data exchange for real-time multiplayer experiences, or professional-grade video conferencing systems used in businesses for high-quality virtual meetings. This category also includes emerging Internet of Things (IoT) devices, like intelligent security cameras and smart home appliances, which constantly transmit and receive data for automation and monitoring purposes. Furthermore, high-performance tablets and laptops also fall under this category, as they require high-speed internet for cloud computing and large file transfers.

In some cases, the user devices 202, 204, and 206 in network environment 200 may optionally utilize network 208 to communicate with other computing devices (e.g., a mobile device(s), a server(s), a personal computer(s), etc.) through cell site 214. The network 208 may be a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Network 208 may be part of a telecommunication network that connects subscribers to their service provider. In aspects, the service provider may be a telecommunications service provider, an internet service provider, or any other similar service provider that provides at least one of voice telecommunications and data services to any or all of the user devices 202, 204, and 206. For example, network 208 may be associated with a telecommunications provider that provides services (e.g., LTE, 4G, 5G, 6G) to the user devices 202, 204, and 206. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1x circuit voice, a 3G network (e.g., CDMA, CDMA2000, WCDMA, GSM, UMTS), a 4G network (WiMAX, LTE, HSDPA), a 5G network, or a 6G network. The network 208 may also be, in whole or in part, or have characteristics of, a self-optimizing network.

In some implementations, cell site 214 is configured to communicate with the user devices 202, 204, and 206 that are located within the geographical area defined by a transmission range and/or receiving range of the radio antennas of cell site 214. The geographical area may be referred to as the “coverage area” of the cell site or simply the “cell,” as used interchangeably hereinafter. Cell site 214 may include one or more base stations, base transmitter stations, radios, antennas, antenna arrays, power amplifiers, transmitters/receivers, digital signal processors, control electronics, GPS equipment, and the like. In particular, cell site 214 may be configured to wirelessly communicate with devices within a defined and limited coverage area. In an exemplary aspect, the cell site 214 comprises a base station that serves at least one sector of the cell associated with the cell site 214, and at least one transmit antenna for propagating a signal from the base station to one or more of the user devices 202, 204, and 206. In other aspects, the cell site 214 may comprise multiple base stations and/or multiple transmit antennas for each of the one or more base stations, any one or more of which may serve at least a portion of the cell. For example, the cell site may comprise a first antenna array 230, a second antenna array 232, and a third antenna array 234, wherein each of the antenna arrays serves a distinct sector (i.e., portion) of the coverage area of the cell 214. In some aspects, the cell site 214 may comprise one or more macro cells (providing wireless coverage for users within a large geographic area) or it may be a small cell (providing wireless coverage for users within a small geographic area).

In some aspects, the SIM QoE server 212 is utilized as a centralized network entity designed to enhance the quality, efficiency, and scalability of services reliant on data collected by SIM applications. The SIM QoE server 212 may act as an intermediary between SIM applets on UEs and external systems, performing tasks such as data aggregation, advanced analytics, and secure communication. The SIM QoE server 212 may process raw network measurement data, such as signal strength metrics (RSSI, RSRP, SNR) and CGIs, received from SIM applets and use algorithms like triangulation and machine learning to determine accurate real-time and historical location information. The SIM QoE server 212 may maintain a centralized database of historical data, helping to enable comprehensive tracking and analysis across multiple devices within the network 208. The SIM QoE server 212 may also securely manage and transmit processed data to authorized external entities while maintaining compliance with privacy and security protocols.

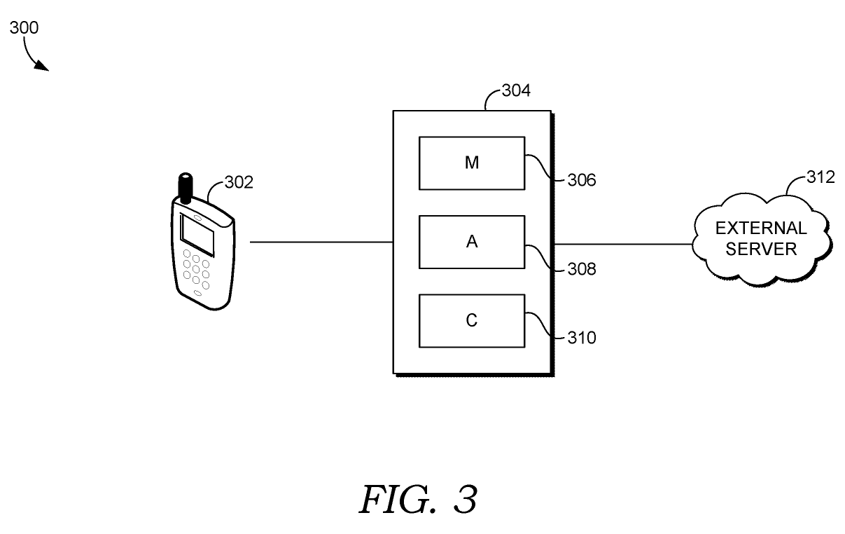

FIG. 3 provides an exemplary network environment in which implementations of the present disclosure may be employed. Such a network environment is illustrated and designated generally as network environment 300. Network environment 300 is but one example of a suitable network environment and is not intended to suggest any limitation as to the scope of use or functionality of the invention. Neither should the network environment be interpreted as having any dependency or requirement relating to any one or combination of components illustrated. The network environment 300 includes a user equipment (UE) 302 that is capable of operating in network environment 300. The network environment 300 additionally comprises one or more hardware and/or software components that, together, make up a SIM applet 304 installed on the SIM within the UE 302. The SIM applet 304 comprises a monitor 306, an analyzer 308, and a controller 310.

The monitor 306 is responsible for determining that the UE 302 has moved locations by monitoring changes in connection to cell sites. Specifically, the monitor 306 detects a movement of the UE 302. This movement detection can be based on the determination that the UE 302 has attached to a new cell site, which triggers the capturing of location information for historical purposes. Upon detecting such a movement, the monitor 306 requests location data associated with the user device, including NMRs and CGIs.

Additionally, the monitor 306 periodically requests NMRs and CGIs at predefined intervals to update the location of the UE 302. These predefined intervals can be dynamically adjusted based on the movement speed of the UE 302, ensuring accurate and timely updates of the location information. This periodic request mechanism allows the SIM applet to continuously monitor the location of the UE 302 and provide real-time updates. The intervals can be configured based on various factors, including the speed of movement and the specific requirements of the network or service provider.

Once the CGI and NMR data is retrieved, the analyzer 308 processes the received NMRs and CGIs using a triangulation algorithm to determine the location of the UE 302. This triangulation algorithm calculates the location by analyzing the signal measurements for each cell site, computing distances between the UE 302 and each of the cell sites based on the signal measurements and the CGIs, and determining an intersection point of the computed distances to pinpoint the location of the UE 302. The triangulation algorithm involves several key steps. Firstly, it analyzes the signal measurements (RSSI, RSRP, SNR) for each cell site to assess the strength and quality of the signals. These measurements are crucial for determining the relative distance between the UE 302 and each cell site. Secondly, the algorithm computes the distances between the UE 302 and the cell sites based on the signal measurements and the CGIs. The distances are calculated using known propagation models and signal attenuation formulas that relate signal strength to distance. Finally, the algorithm determines an intersection point of the computed distances to accurately estimate the location of the UE 302.

The analyzer 308 validates the received CGIs against a database of known cell sites to ensure the accuracy of the location determination. The analyzer 308 can also employ machine learning algorithms to refine the accuracy of the location determination over time based on historical location data. The validation process involves comparing the received CGIs with a database of known cell sites to confirm their authenticity and accuracy. The use of machine learning techniques allows the system to learn from historical data and improve the precision of the location determination algorithm. In certain embodiments, machine learning techniques are employed to enhance the accuracy, efficiency, and reliability of the system’s location determination and historical data management. The SIM application integrates one or more supervised learning models trained on historical signal data to identify patterns and optimize performance. By continuously analyzing incoming data, the system can dynamically adjust the frequency of NMR and CGI requests, enhance the accuracy of location estimates, and detect anomalies. These enhancements ensure reliable operation even in challenging environments, such as urban areas with high signal interference or indoor locations with limited signal penetration. Additionally, reinforcement-learning models can be employed to adjust sampling strategies over time, minimizing network and device resource consumption while maintaining accurate real-time location tracking.

The controller 310 manages the overall operation of the SIM applet 304, including the secure communication of the determined current location and historical location and record to an external server 312. The controller 310 uses a secure communication protocol such as TLS/SSL to transmit the location data to the external server 312, ensuring the privacy and security of the location information. This step ensures that the location information is securely delivered to the network or service provider requesting it, maintaining the confidentiality and integrity of the transmitted data. The secure transmission prevents unauthorized access and ensures that the location data is only accessible to authorized entities.

The controller 310 manages the storage of historical location data within the SIM. This involves storing the determined location data at predefined intervals to create a historical location record. The historical data is securely maintained within the SIM and can be retrieved when needed. The controller 310 ensures that the historical location data is periodically updated based on the movement of the UE 302 and changes in its connection to cell sites.

In an additional embodiment, the SIM applet 304 is configured to respond to location requests from external servers or network entities. Upon receiving a request for the current location of the UE 302, the SIM applet 304, via the monitor 306, initiates a process to retrieve updated location data. The monitor 306 first checks whether the UE 302 has moved to a new cell site or if it remains connected to the same set of cell sites. If the UE 302 has moved, the monitor 306 requests updated network measurement reports (NMRs) and cell global identities (CGIs) from the user device, reflecting the UE 302's current network environment. These data points, collected from the newly attached cell sites, provide real-time signal strength metrics.

The analyzer 308 processes this new data by recalculating the UE 302’s current location using the triangulation algorithm described previously. This recalculation involves the same steps: analyzing the signal measurements for each cell site, computing the distances between the UE 302 and each cell site using signal attenuation formulas, and determining the intersection point of the computed distances. Simultaneously, the SIM applet 304 retrieves the historical location record stored within the SIM. This record contains location data captured at predefined intervals, providing a log of the UE 302’s movements over time. Once the analyzer 308 determines the current location, the SIM applet 304 combines both the historical location data and the newly determined current location into a single data package.

The controller 310 then manages the secure transmission of this data package to the requesting external server 312. Utilizing encryption protocols such as TLS/SSL, the controller 310 ensures that both the historical location record and the current location of the UE 302 are securely transmitted. This process prevents unauthorized access and guarantees that the location data is only available to authorized entities. The ability of the SIM applet 304 to seamlessly provide both real-time location information and historical movement data ensures that the system can meet the demands of various applications, such as location-based services, network optimization, and compliance with regulatory requirements for location tracking.

In an alternative embodiment, the SIM applet 304 within the UE 302 collects NMRs and CGIs and securely transmits this data to a SIM QoE server (e.g., SIM QoE server 212) within the network (e.g., network 208). This embodiment delegates the computationally intensive processing tasks, such as triangulation and machine learning-based analysis, to the SIM QoE server, reducing the processing load on the UE 302 and the SIM applet 304. For example, the monitor 306 within the SIM applet 304 may detect movement of the UE 302 by identifying changes in connection to cell sites, as indicated by the newly attached cell sites as discussed previously. Upon detecting a movement or at predefined internals, the monitor 306 may collect location data, including NMRs and CGIs associated with the currently connected cell sites. Instead of analyzing this data locally, the controller 310 may securely transmit the collected data to the SIM QoE server using encrypted communication protocols.

In this alternative embodiment, the SIM QoE server receives the NMR and CGI data and may one or more of triangulation, validation, and machine learning integration. For example, using the same triangulation algorithm described above, the SIM QoE server determines the UE’s 302 current location by analyzing signal measurements, calculating distances between the UE 302 and cell sites using propagation models, and identifying an intersection point to pinpoint the location. The SIM QoE server may validate the CGIs against a database of known cell sites to confirm the accuracy of the computed location. Additionally, the SIM QoE server may apply machine learning models trained on historical signal data to refine location determination, optimize sampling intervals, and/or detect anomalies. The relatively larger computational resources of the SIM QoE server may allow for advanced analysis, including reinforcement learning to adjust data collection strategies for improved efficiency.

Continuing with the alternative embodiment, the SIM QoE server may maintain a centralized historical location database for each UE, including the UE 302. This database may aggregate location data received from the SIM applet 304 over time, allowing comprehensive movement tracking and historical analysis. The centralized nature of the SIM QoE server allows it to efficiently manage and correlate location data from multiple UEs within the network, which may enhance network-wide analytics and optimization. Upon receiving a request for the location of the UE 302 from the external server 312, the SIM QoE server may retrieve the UE’s 302 historical location data from its database, combine the historical data with the latest calculated real-time location into a unified data package, and transmit the data package securely to the external server 312 using encryption protocols. Some advantages of this alternative embodiment included reduced device overhead by offloading computational tasks to the SIM QoE server and reducing the processing and power consumption demands on the UE 302 and the SIM applet 304. Furthermore, the SIM QoE server can handle location data processing for multiple UEs, helping enable network-level optimization and analytics, as well as allowing a network operator to update algorithms or machine learning models on the SIM QoE server instead of the SIM applet 304 or the UE 302.

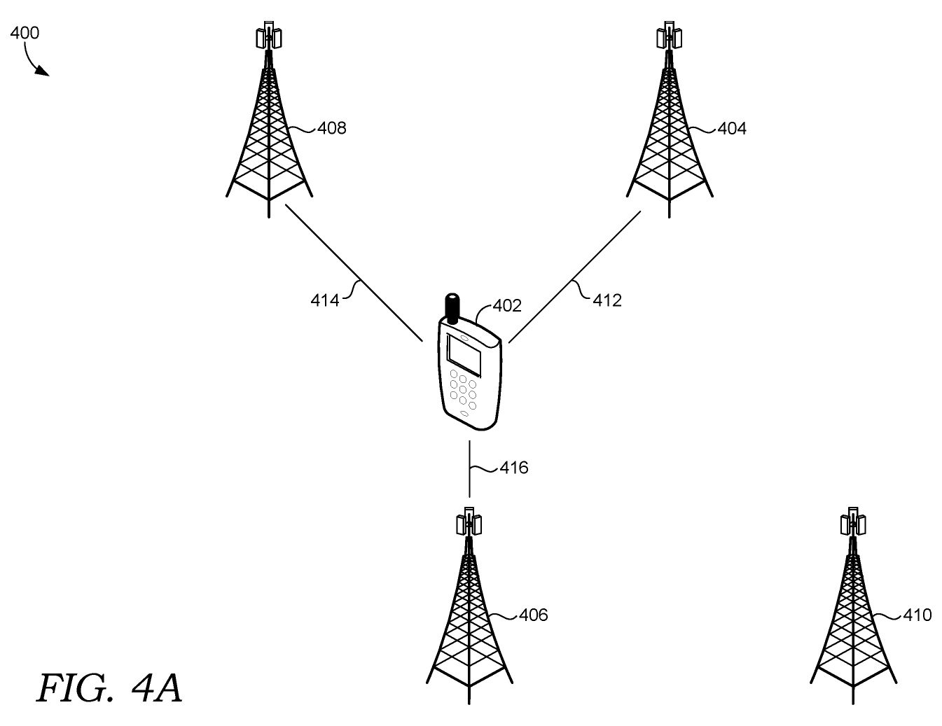

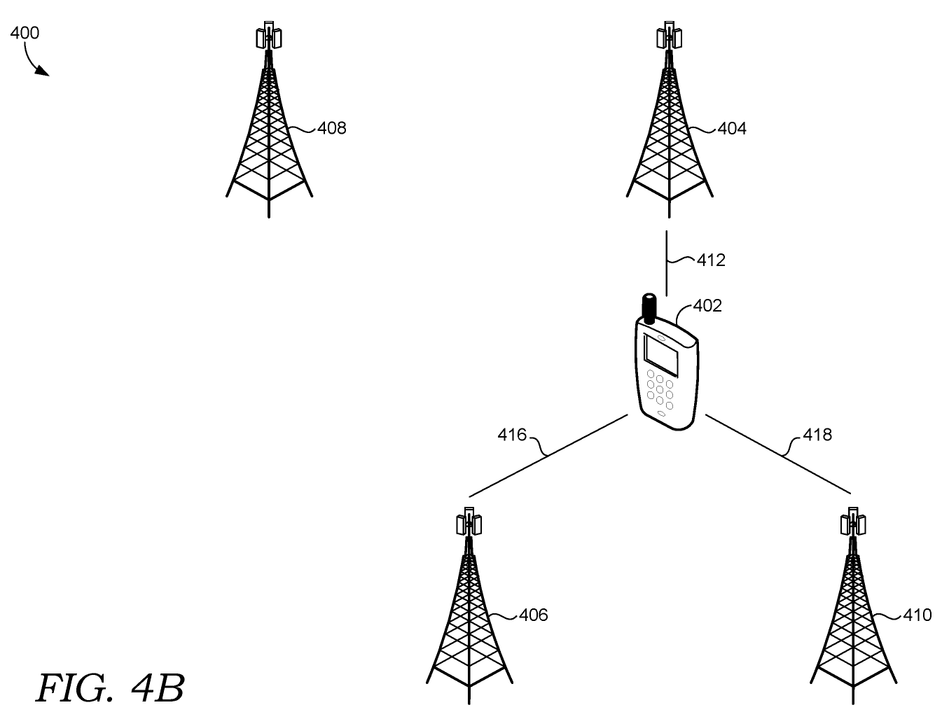

FIGS. 4A and 4B provide exemplary network environments in which implementations of the present disclosure may be employed. These network environments are illustrated and designated generally as network environment 400. Network environment 400 is but one example of a suitable network environment and is not intended to suggest any limitation as to the scope of use or functionality of the invention. Neither should the network environment be interpreted as having any dependency or requirement relating to any one or combination of components illustrated.

Network environment 400 includes a UE 402, a first cell site 404, a second cell site 406, a third cell site 408, and a fourth cell site 410. The UE 402 is capable of operating within the network environment 400 and communicating with multiple cell sites. Each cell site represents a network node providing wireless communication coverage to the UE 402. These cell sites are part of a larger cellular network infrastructure that facilitates the transmission and reception of data.

FIG. 4A illustrates the UE 402 attached to the first cell site 404 through connection 412, second cell site 406 through connection 416, and third cell site 408 through connection 414. In this state, the UE 402 is maintaining optimal connectivity with these cell sites, allowing for seamless communication. The SIM applet, installed on the SIM within the UE 402, constantly monitors the signal strengths from these cell sites to ensure the best possible connection.

FIG. 4B shows the UE 402 moved to attach to the fourth cell site 410 through connection 418 and not to the third cell site 408. This movement prompts the SIM applet to gather NMR and CGI data to generate a historical location data set. The SIM applet detects the UE 402's attachment to the new cell site 410 and triggers the capturing of location information for historical purposes. This detection of the movement can be based on the UE 402 attaching to a new cell site, such as the fourth cell site 410 or detaching from the first cell site 404. The movement of the UE 402 can also be detected based on the UE 402 moving more than a pre-determined distance based on GPS data or other location data.

The SIM applet requests location data associated with the UE 402, including NMRs and CGIs. The NMRs include signal measurements such as the RSSI, the RSRP, the SNR, or any other signal measurements. The CGIs provide the identification of the specific locations of the cell sites. The SIM applet processes the received NMRs and CGIs using a triangulation algorithm to determine the location of the UE 402. This triangulation algorithm calculates the location by analyzing the signal measurements for each cell site, computing distances between the UE 402 and each of the cell sites based on the signal measurements and the CGIs, and determining an intersection point of the computed distances to pinpoint the location of the UE 402. The triangulation algorithm involves several key steps: analyzing signal measurements (RSSI, RSRP, SNR), computing distances using known propagation models and signal attenuation formulas, and determining the intersection point of the computed distances.

In one embodiment, the SIM application processes the collected location data, including the signal measurements (RSSI, RSRP, SNR), and computes the distances between the user device and the cell sites using known signal attenuation formulas. These formulas relate the measured signal strength to the distance between the user device and the respective cell sites. The distance between the user device and each cell site can be determined using various models such as the Okumura-Hata model. The Okumura-Hata formula calculates the path loss (signal attenuation). This formula, along with additional propagation models, can be used to calculate the distance from the signal strength, improving the precision of the triangulation algorithm. For more complex environments, such as dense urban areas, additional corrections can be applied to the model to account for signal interference and multipath propagation. The use of signal attenuation formulas ensures that the distance between the user device and each cell site is calculated accurately, which is critical for determining the user’s precise location.

The SIM applet manages the overall operation, including the secure communication of the determined location to an external server. A secure communication protocol such as TLS/SSL can be used to transmit the location data to the external server, ensuring the privacy and security of the location information.

Additionally, the SIM applet periodically requests NMRs and CGIs at predefined intervals to update the location of the UE 402. These predefined intervals can be dynamically adjusted based on the movement speed of the UE 402, ensuring accurate and timely updates of the location information. This periodic request mechanism allows the SIM applet to continuously monitor the location of the UE 402 and provide real-time updates.

In one aspect, each of the received CGIs are validated against a database of known cell sites to ensure the accuracy of the location determination. The storage of historical location data within the SIM involves storing the determined location data at predefined intervals to create a historical location record. The historical data is securely maintained within the SIM and can be retrieved when needed. The historical location data and historical record is periodically updated based on the movement of the UE 402 and changes in its connection to cell sites. For example, each time the UE 402 changes its location or connection to cell sites, the SIM applet updates the historical record with the location of the UE 402 and the time that it moved to then new location.

In a further embodiment, the SIM applet receives a request from a network for the current location of the UE 402. Upon receiving a request from the network for the location of the user device, a process is initiated to determine the current location. The SIM applet requests updated NMRs and CGIs from the UE 402, and then recalculates a current location using this new data. The updated current location, along with the historical location and/or the historical location record, are then provided to an external server. The NMRs and CGIs are stored temporarily within the SIM before being transmitted to the external server. This secure storage mechanism protects the data from unauthorized access and ensures that the location information is only available to authorized entities.

In some embodiments, the SIM applet further includes a mechanism for generating an alert on the UE 402 indicating that a location request has been processed. This alert informs the user that the location of the UE 402 has been determined and communicated to the network. In other embodiments, the SIM applet can log each location determination event along with a timestamp and send alerts to a network operator if anomalies or discrepancies are detected. This logging provides a detailed record of location data, useful for further analysis or troubleshooting.

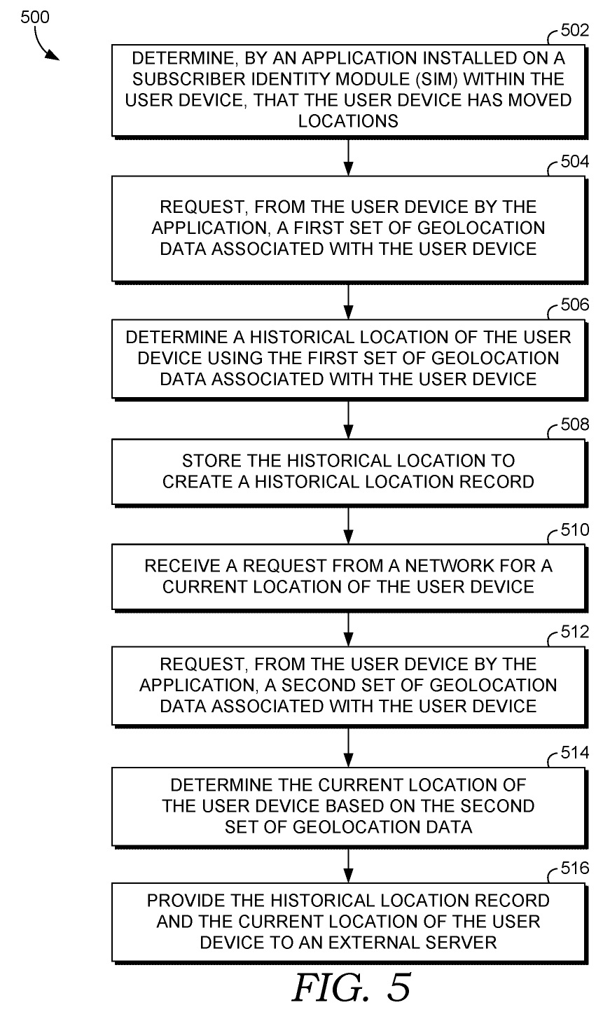

Turning now to FIG. 5, a flow chart is provided that illustrates one or more aspects of the present disclosure relating to a method 500 for determining the location of a user device. The method 500 begins at block 502 with the determination, by an application installed on a SIM within the user device, that the user device has moved locations. This initial step involves the SIM application detecting that the user device has attached to a new cell site. This movement triggers the SIM application to capture location data to update the historical location record. Upon detecting this movement, the SIM application prepares to process the request by engaging with the user device's internal components and network interfaces.

At block 504, the SIM application requests, from the user device, location data associated with the user device. This step involves the SIM application sending a command to the user device to collect and return the required location data. The location data includes the NMRs for each cell site the UE is attached to. Each NMR comprises various signal measurements such as RSSI, RSRP, and SNR. These signal measurements provide critical information about the quality and strength of the signals received by the user device from different cell sites. Additionally, the location data includes CGIs, which provide the identification of the specific locations of the cell sites. Each CGI is a unique identifier associated with a cell site, allowing the network to pinpoint the exact geographical location of the cell site. The user device collects the location data by measuring the signals from all the cell sites it is connected to and retrieving the corresponding identifiers.

Upon receiving the location data from the user device, the method proceeds to block 506, where the SIM application determines a historical location of the user device using the location data associated with the user device. This determination involves processing the collected location data to calculate the historical location of the user device. The SIM application uses a triangulation algorithm to determine this historical location. The triangulation algorithm involves several steps: analyzing the signal measurements (RSSI, RSRP, SNR) for each cell site to assess the strength and quality of the signals. The algorithm computes the distances between the user device and the cell sites based on the signal measurements and the CGIs using known propagation models and signal attenuation formulas and determines an intersection point of the computed distances to pinpoint the precise historical location of the user device. By considering the signal strength and location data from multiple cell sites, the algorithm enhances the accuracy of the location determination. The use of multiple cell sites and signal measurements helps to mitigate the effects of signal interference and multipath propagation, leading to a more reliable location estimate.

At block 508, the method involves storing the determined historical location data at predetermined intervals to create a historical location record. The SIM application securely stores the historical location data within the SIM, ensuring it is available for future reference. This historical location record is maintained to provide a comprehensive log of the user device's movements over time.

The method continues at block 510 with the SIM application receiving a request from the network for the location of the user device. This request typically originates from a network server or an external application that requires the current location of the user device for various purposes, such as location-based services or network optimization. Upon receiving this location request, the SIM application prepares to process the request by engaging with the user device's internal components and network interfaces.

At block 512, the SIM application requests, from the user device, one or more NMRs and one or more CGIs for each cell site that the user device is attached to. This step involves the SIM application sending a command to the user device to collect and return the required NMRs and CGIs, similar to the process in block 504. These additional data points are used to refresh the location of the user device based on the most recent signal and network information.

The method proceeds to block 514, where the SIM application determines the current location of the user device based on the NMR and CGI request using the triangulation algorithm. The SIM application processes the collected NMRs and CGIs to calculate the current location of the user device, following the same steps outlined in block 506. The triangulation algorithm processes the NMRs and the CGIs to compute the device's current location based on the latest data.

At block 516, the method communicates both the historical location record and the current location of the user device to an external server. The SIM application packages the location data for both the historical location record and the current location securely and uses a secure communication protocol such as TLS/SSL to transmit the data to the external server. The external server, upon receiving the location data, can use it for various applications such as providing location-based services, enhancing network performance, or supporting emergency services.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for determining a location for a user device, the method comprising:
determining, by an application installed on a subscriber identity module (SIM) within the user device, that the user device has moved from a first location to a second location;
based on the determination that the user device has moved, requesting from the user device, by the application, a first set of one or more network measurement reports (NMRs) and a first set of one or more cell site location information (CGIs) for each cell site that the user device is attached to;
determining a historical location of the user device based on the first set of one or more NMRs and the first set of one or more CGIs;
storing the historical location on the SIM to create a historical location record;
receiving, by the application, a request from a network for a current location of the user device;
requesting, by the application, a second set of one or more NMRs and a second set of one or more CGIs for each cell site that the user device is attached to from the user device;
determining the current location of the user device based on the second set of one or more NMRs and the second set of one or more CGIs;
communicating the historical location record and the current location of the user device to an external server.

2. The method of claim 1, wherein each of the first set of one or more NMRs comprise one or more signal measurements for each cell site that the user device is attached to.

3. The method of claim 1, wherein each of the first set of one or more CGIs comprise an identification of a specific location for each cell site that the user device is attached to.

4. The method of claim 1, wherein the current location is determined by:
analyzing one or more signal measurements for each cell site that the user device is attached to;
computing, one or more distances between the user device and each cell site that the user device is attached to based on the second set of one or more NMRs and the second set of one or more CGIs; and
determining an intersection point of the one or more distances to pinpoint the location of the user device.

5. The method of claim 1, wherein one or more signal measurements in the second set of one or more NMRs include one or more of the following: a received signal strength indicator (RSSI), a reference signal received power (RSRP), and a signal-to-noise ratio (SNR).

6. The method of claim 1, wherein determining that the user device has moved from the first location to the second location is based at least in part on determining that the user device has attached to one or more new cell sites.

7. The method of claim 1, wherein the determining that the user device has moved from the first location to the second location is based at least in part on determining that the user device has detached from one or more cell sites.

8. The method of claim 1, further comprising validating the second set of one or more CGIs against a database of known cell sites.

9. The method of claim 1, wherein determining the current location of the user device comprises using a machine learning algorithm to refine an accuracy of a location determination over time.

10. The method of claim 1, further comprising generating an alert on the user device indicating that a location request has been processed by the application on the SIM.

11. The method of claim 1, wherein the first set of one or more NMRs and the first set of one or more CGIs are stored for a predetermined period.

12. A system for determining a location for a user device, the system comprising:
the user device configured to communicate with one or more cell sites associated with a network;
a subscriber identity module (SIM) installed within the user device, the SIM comprising an application configured to:
determine that the user device has moved from a first location to a second location;
based on the determination that the user device has moved, request a first set of one or more network measurement reports (NMRs) and first set of one or more cell site location information (CGIs) from the user device;
determine a historical location of the user device based on the first set of one or more NMRs and the first set of one or more CGIs;
receive a request from the network for a current location of the user device and the historical location of the user device;
request a second set of one or more NMRs and a second set of one or more CGIs from the user device;
determine the current location of the user device using the second set of one or more NMRs and the second set of one or more CGIs; and
communicate the current location of the user device and the historical location of the user device to an external server.

13. The system of claim 12, wherein determining that the user device has moved from the first location to the second location is based on a change in one or more CGIs associated with the user device.

14. The system of claim 12, wherein determining that the user device has moved from the first location to the second location is based on a set of location data provided by the user device.

15. The system of claim 12, wherein determining that the user device has moved from the first location to the second location is based on the user device moving at least more than a predetermined distance from the first location.

16. The system of claim 12, wherein the application generates an alert on the user device indicating that a location determination process has been initiated.

17. The system of claim 12, wherein a historical location record is generated based on the first set of one or more NMRs and the first set of one or more CGIs.

18. The system of claim 12, wherein determining that the user device has moved is based in part on the user device attaching to one or more new cell sites.

19. A subscriber identity module (SIM) for determining and storing location data of a user device, the SIM comprising:
an application installed on the SIM, the application configured to:
determine that the user device has moved from a first location to a second location;
based on the determination that the user device has moved, request one or more network measurement reports (NMRs) and one or more cell site location information (CGIs) from the user device;
determine a historical location of the user device using a triangulation algorithm that processes the one or more NMRs and the one or more CGIs associated with the user device;
generate a historical location record based on the historical location;
receive a request from an external network for a current location of the user device;
determine the current location of the user device based on the request; and
transmit the historical location and the current location to the external server.

20. The SIM of claim 19, wherein determining that the user device has moved from the first location to the second location is based on detecting a change in a signal strength of one or more cell sites to which the user device is attached.
